(19) United States
(12) Patent Application Publication
(10) Pub. No.: US 2007/0183688 A1
(43) Pub. Date: Aug. 9, 2007

(54) Data management system and method

(76) Inventor: Gary Hollfelder, Montville, NJ (US)

Correspondence Address: KENYON & KENYON LLP, ONE BROADWAY, NEW YORK, NY, 10004, US

(21) Appl. No.: 11/347,143

(22) Filed: Feb. 3, 2006

(51) Int. Cl. G06K 9/54

(52) U.S. Cl. 382/305

(57) ABSTRACT

A method includes: acquiring at least one digital image; acquiring a first data identifier associated with each digital image; receiving a scan of a paper including at least one scan of handwritten information and a second data identifier associated with each handwritten information; and associating each digital image with a corresponding scan of handwritten information in accordance with the first data identifier corresponding to the second data identifier.

### FIELD OF INVENTION

The present invention relates to a data management system and method.

### BACKGROUND

Data may be captured from different sources or inputted in different manners. In some instances, data from different sources may need to be manipulated for use or analysis.

Data management encompasses all disciplines related to managing data as a valuable resource. One aspect of data management is to manipulate and correlate data of different types collected from different sources into a database where the data may be sorted, analyzed and retrieved. Data may be digital images, digital voice recordings, text, numbers or dates. Data may be captured by a various input sources, e.g., a digital camera, a digital voice recorder, or a scanner. Data may also be inputted by a user into a computer. Data may also be transmitted from one computer to another.

The acquisition, storage and correlation of certain types of data may prove difficult in certain circumstances. For example, an insurance adjuster who is required to inspect and evaluate an insurance claim may be required to take photographs of the insured property, make observations of the insured property, take notes relating to the insured property, etc. All of the foregoing may be performed on-site at the location of the insured property, i.e., remotely from the adjuster's office. When the adjuster returns to his office from on-site inspections, he may be required to manually correlate his notes, observations, pictures, etc., possibly having only paper copies of these materials and may have various papers, pictures, etc., from a number of claims. This may lead to errors in maintaining materials from each claim separately organized. Furthermore, a system designed to acquire, organize and correlate such data is believed would be helpful.

Another fields that may require remote site inspection and data acquisition that may find use in such a system include government building inspectors, utility inspectors, etc. The medical field may also find use in such a system. In this regard, x-rays, scans (e.g., CAT scans, MRI scans, etc.) or other data may need to be correlated with handwritten notes from a doctor, nurse or other medical professional or paraprofessional.

### SUMMARY

Different types of data may be captured or inputted from different sources and collected on a server. A system and method is provided for managing data on the server. A first data type and a second data type may be supported. For example, the first data type may be a digital picture or a digital sound or voice file. For example, the second data type may be handwritten information or an image or a scan of a handwritten information. The first data type and the second data type are captured via different inputs. The first data type may be captured through a digital camera or a digital voice recorder, and the second data type may be captured via a paper that is written on by a user and subsequently scanned.

Each first data may be associated with a second data when captured. The first data and the second data may be downloaded onto a server, which associates the first data and the second data and stores both in a database.

According to an example embodiment of the present invention, a method may include: receiving a digital image; receiving a first data identifier associated with the digital image; receiving a scan of a paper further at least one scan of a handwritten information and at least one second data identifier, each data identifier associated with one scan of a handwritten information; and associating the digital image with the one scan of a handwritten information if the first data identifier corresponds with the one second data identifier. The first identifier and the at least one second data identifier may be bar codes. The method may further include storing the digital image, the one scan of a handwritten information, the first data identifier and the a corresponding second data identifier in a database. The method may further include printing the digital image and its associated scan of a handwritten information.

According to an example embodiment of the present invention, a method may include: receiving a first piece of data; receiving a first data identifier associated with the first piece of data; receiving a scan, the scan further including, at least a second piece of data, and at least one second data identifier, each second data identifier associated with one second piece of data; and associating the first piece of data with the second piece of data if the first data identifier corresponds with the second data identifier. The first piece of data may be a digital image or a digital sound recording. The second piece of data may be a scan of a handwriting. The scan may be a scan of a paper. The first identifier and the at least one second data identifier may be bar codes. The method may further include storing the first piece of data, the second piece of data, the first data identifier and the at least one second data identifier in a database. The method may further include printing the first piece of data and the second piece of data.

According to an example embodiment of the present invention, a system may include: a medium further including, at least one data identifier and at least one second piece of data, each second piece of data associated with a data identifier; a data capture device further including an identifier scanner configured to capture a data identifier from the medium, and a sensor configured to capture a first piece of data wherein the data capture device is configured to associate each first piece of data with the data identifier; a medium scanner configured to scan the at least one data identifier and the at least one second piece of data included on the paper; and a processor in communication with the data capture device and the medium scanner, the processor configured to, receive the first piece of data and the data identifier associated with the first piece of data from the data capture device, receive the at least one second piece of data and the data identifier associated with the second piece of data from the medium scanner, and associate the first piece of data with the second piece of data associated with the corresponding data identifier. The medium may be a paper and further include a medium identifier. The data identifier may be a bar code. The first piece of data may be a digital image. The second piece of data may be a scan of a handwritten information. The data capture device may be a digital camera. The sensor may be an image sensor.

According to an example embodiment of the present invention, a system may include: a paper further including a paper identifier, at least one data identifier, wherein each data identifier is a bar code, and at least one space for a handwritten information, each handwritten information associated with a data identifier; a camera further including, a bar code scanner configured to capture a data identifier from the paper, an image sensor configured to capture an image, wherein the camera is configured to associate each image with the data identifier; a scanner configured to scan the paper identifier, the at least one data identifier and the at least one space for handwritten information included on the paper; and a processor in communication with the camera and the scanner, the processor configured to receive the paper identifier from the scanner, receive the image and the data identifier associated with the image from the camera, receive the at least one handwritten information and the data identifier associated with each handwritten information from the scanner, and associate the image with the handwritten information associated with the corresponding data identifier.

According to an example embodiment of the present invention, a method may include: acquiring at least one digital image; acquiring a first data identifier associated with each digital image; receiving a scan of a paper including at least one scan of handwritten information and a second data identifier associated with each handwritten information; and associating each digital image with a corresponding scan of handwritten information in accordance with the first data identifier corresponding to the second data identifier.

The first identifier and second data identifier may include bar codes.

The method may include storing the digital image, the scan of handwritten information, the first data identifier and the second data identifier in a database.

The method may include printing the digital image and the associated scan of handwritten information.

According to an example embodiment of the present invention, a method includes: acquiring at least one piece of first data; acquiring a first data identifier associated with each piece of first data; receiving a scan including at least one second piece of data and a second data identifier associated with each piece of second data; and associating each first piece of data with a corresponding second piece of data in accordance with the first data identifier corresponding to the second data identifier.

The first piece of data may include at least one of (a) a digital image and (b) a digital sound recording.

The second piece of data may include a scan of handwritten information.

The scan may include a scan of a paper.

The first identifier and the second data identifier may include bar codes.

The method may include storing the first piece of data, the second piece of data, the first data identifier and the second data identifier in a database.

The method may include printing the first piece of data and the second piece of data.

According to an example embodiment of the present invention, a system includes: a medium including at least one second data identifier and a second piece of data associated with each second data identifier; a data capture device including an identifier scanner adapted to capture the each second data identifier from the medium as a first data identifier and a sensor adapted to capture a first piece of data corresponding to each captured data identifier, the data capture configured to associate each first piece of data with the corresponding data identifier; a medium scanner configured to scan the medium to acquire each second data identifier and each second piece of data; and a processor adapted to receive each first piece of data and each first data identifier associated with the first piece of data from the data capture device, to receive each second piece of data and each second data identifier associated with the second piece of data from the medium scanner, and to associate each first piece of data with a corresponding second piece of data in accordance with the first data identifier corresponding to the second data identifier.

The medium may include a paper, and the medium may include a medium identifier.

Each data identifier may include a bar code.

The first piece of data may include a digital image.

The second piece of data may include a scan of handwritten information.

The data capture device may include a digital camera.

The sensor may include an image sensor.

According to an example embodiment of the present invention, a system includes: a paper including (a) at least one first data identifier that includes a bar code and (b) a space arranged to receive handwritten information corresponding to each first data identifier; a camera adapted to capture an image; a barcode scanner adapted to scan the first data identifier from the paper as a second data identifier; a scanner adapted to scan the paper and acquire the first data identifier and the handwritten information; and a processor adapted to receive the image from the camera, to receive the first data identifier and the handwritten information from the scanner, to receive the second data identifier from the barcode scanner, and to correlate the image and the handwritten information in accordance with the first data identifier corresponding to the second data identifier.

### BRIEF DESCRIPTION OF THE DRAWINGS

FIG. 1 schematically illustrates a system according to an example embodiment of the present invention.

FIG. 2 illustrates a method according to an example embodiment of the present invention.

FIG. 3 schematically illustrates a digital camera device that is usable in connection with the system illustrated in FIG. 1 and/or the method illustrated in FIG. 2.

FIG. 4 schematically illustrates a paper that is usable in connection with the system illustrated in FIG. 1 and/or the method illustrated in FIG. 2.

FIG. 5a schematically illustrates a data structure that may be used in connection with the system illustrated in FIG. 1 and/or the method illustrated in FIG. 2.

FIG. 5b illustrates a data structure entry that may be used in connection with the system illustrated in FIG. 1 and/or the method illustrated in FIG. 2.

### DETAILED DESCRIPTION

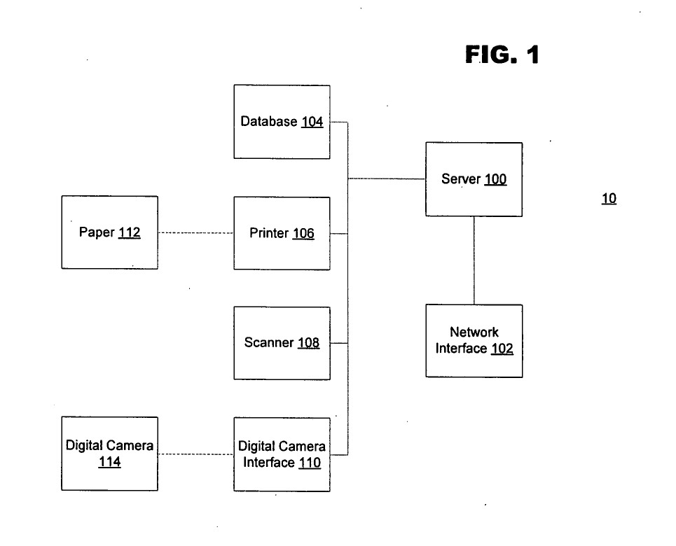

FIG. 1 schematically illustrates a system 10, which may be used to correlate various data input from a plurality of data sources. The system 10 may include a server 100 and a digital camera 114.

The server 100 may be a personal computer accessible to a user. For example, the server 100 may include a display for displaying information and a keyboard and a mouse pointer for receiving inputs from the user. The server 100 may be in communication with a network interface 102. For example, the network interface 102 may be configured to carry communications between the server 100 and a network. For example, the network may include the Internet, a virtual private network (VPN), a wide area network (WAN), a local network, another network, etc. For example, the network may allow a computer remote from the server 100 to access the server 100 and the functionality of the system 10.

The server 100 may be configured to execute server applications. For example, server applications may include a web server if the server 100 is connected to the Internet through the network interface 102.

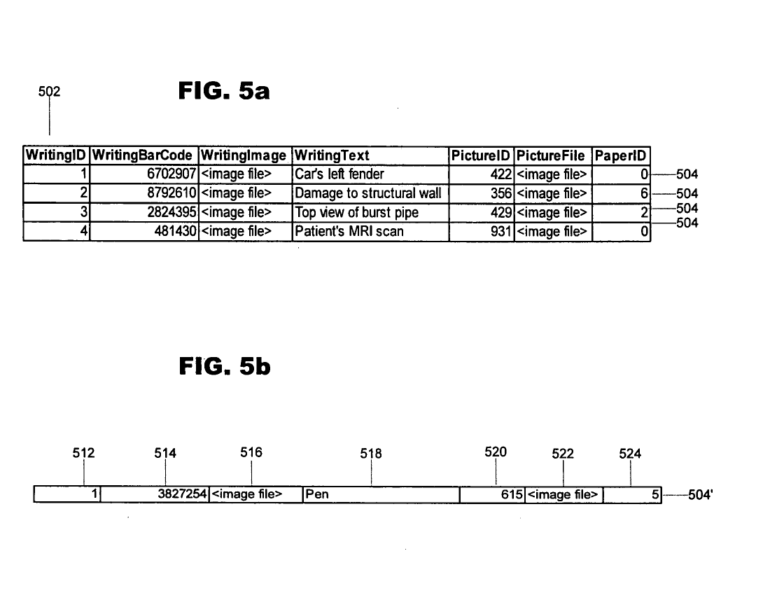

The server 100 may be in communication with a database 104. The database 104 may be remote from the server 100 or may be a server application executed on the server. The database 104 may be a relational database or another form of data storage. The database 104 may store data in the data structures illustrated in FIGS. 5a and 5b.

The server 100 may be in communication with a printer 106. For example, the printer 106 may be an ink-jet printer, a laser printer, etc. The printer 106 may be configured to print a paper 112, such as that illustrated in FIG. 4.

The server 100 may be in communication with a scanner 108, which is configured to scan and capture data from the paper 112 as explained in further detail below.

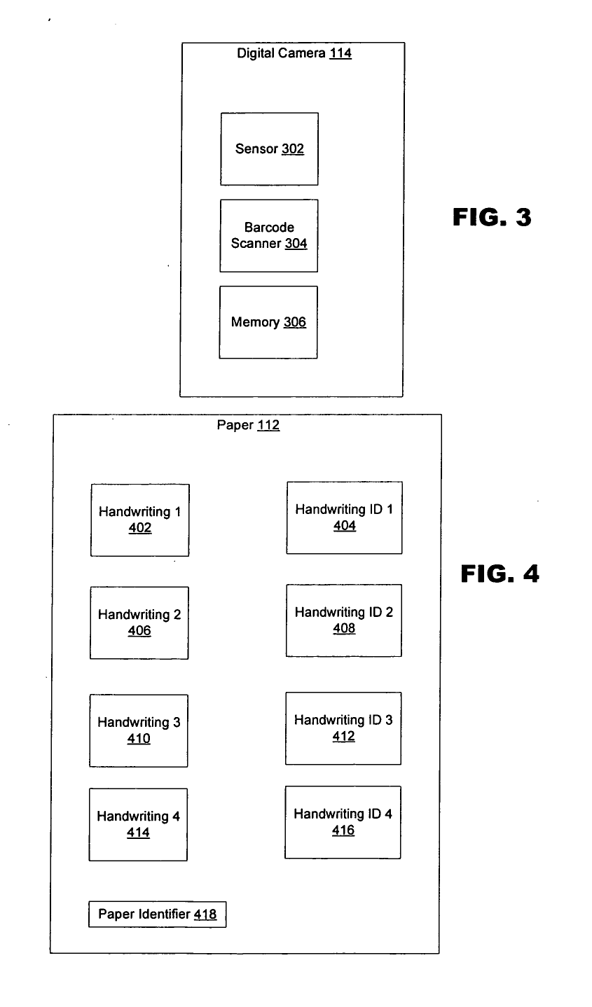

The server 100 may be in communication with a digital camera interface 110, which is configured to interface with a digital camera 114, such as that illustrated in FIG. 3.

As indicated above, a system, such as that illustrated in FIG. 1, may be particularly suitable, for example, for use by an insurance adjuster who is required to evaluate an insurance claim. In response to an insurance claim by an insured person, the printer 106 may print a paper 112, which include such identifying data as the insured's name, a description of the insured property, a location of the insured property, a policy number, etc. In addition, the paper 112 may include defined areas for receiving handwritten notes from the adjuster during the adjuster's field inspection of the insured property. As described more fully below, the paper 112 may include one or more unique identification codes, e.g., bar codes, printed thereon. These codes may be scannable or readable by, e.g., conventional scanning or image acquisition equipment. Each identification code corresponds to a respective defined area for receiving the handwritten notes from the adjuster. Each combination of identification code and defined area may correspond to a predetermined aspect of the inspection. For example, if the insured property is an automobile, the adjuster may be instructed by the insurance company to obtain information, including photographs and observations, on the condition of the automobile by taking photographs of, e.g., the front, rear, two sides, etc. The insurance company may also desire to verify that the inspected automobile is actually the insured automobile. Thus, the adjuster may be directed to observe and photograph the VIN number, license plate, registration sticker, inspection sticker, etc.

With this paper 112 in hand, the adjuster visits the site of the insured property. With digital camera 114, the adjuster takes photographs of the insured property at its location, e.g., based on instructions included on the paper 112 or based on on-site observations. The adjuster may also enter hand-written notes on the paper 112 in the areas provided thereon. For example, the paper 112 may include an indication or instruction to take a photograph of the driver's side and passenger side of an insured automobile. In this example, the paper 112 would include two identification codes and two defined areas for receiving hand-written notes. One identification code and one defined area corresponds to the driver's side, and the other identification code and defined area corresponds to the passenger side. The camera may include a reader or scanner to read or scan the identification code so that when each photograph is taken, it is correlated to an identification code. Each defined area for receiving handwritten notes will also be correlated to a corresponding identification code, and respective photograph, as more fully described below.

As indicated below, it is believed that a digital camera having a barcode reader is available as a Ricoh Caplio Pro G3 digital camera with an optional barcode scanner module.

After the inspection is completed, the adjuster may connect the digital camera 114 to the server 100 via the digital camera interface 110 to retrieve the photographs taken during the inspection. The scanned or read identification codes are also retrieved from the digital camera 114 by the server 100. The paper 112, including the handwritten notes and identification codes, are scanned by scanner 108 to acquire an image of the paper 112. The server 100 is programmed to recognize/decode the scanned identification codes and to correlate the acquired handwritten notes with the respective identification code and the photograph corresponding to the respective identification code. Thus, the handwritten note, photograph and identification code are correlated to one another and subsequent processing or printing of the handwritten note and/or photograph may be done in accordance with the corresponding identification code. It should be appreciated that correlation of myriad types of data may be accomplished in similar manners.

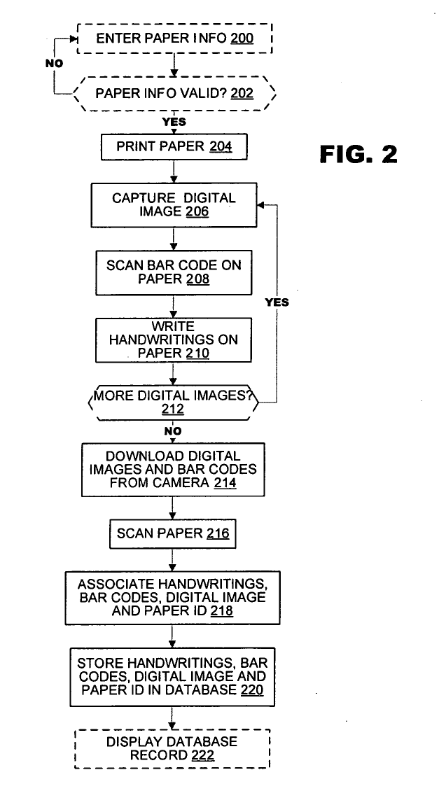

FIG. 2 illustrates a method according to an example embodiment of the present invention. For example, the method may be used to manipulate data used by an adjuster of an insurance company as described in the example above. The paper 112 may represent a dispatch ticket, which includes information such as a description of a claim, an address, an incident identifier, a dispatcher identifier, an adjuster identifier, etc. This paper 112 may be provided to the adjuster who brings it to the scene or site of the insured property.

In step 200, a user may optionally enter paper information. For example, the paper information may be entered by the user at the server 100 as depicted in FIG. 1.

Alternatively, in the example above, the paper information may be entered at a computer remote from the server 100, for example, at a central location such as the insurance company headquarters remote from the adjuster's location. The paper information may be received by the server 100 through the network interface 102.

In step 202, the method optionally checks the validity of the paper information entered in step 200. For example, paper information may be checked for formatting and other errors. If the paper information is correct, the procedure proceeds to step 204.

If the paper information contains errors, the method returns to step 200, where the paper information is received again. For example, the user may be informed of the error and prompted to re-enter the paper information. Alternatively, an error message may be sent to the central location and a replacement paper information received.

In step 204, the paper 112 is printed, and the printed paper 112 is provided to the user, e.g., the insurance adjuster in the example described above.

In step 206, a digital image is captured by, for example, a digital camera 114 or other imaging device. The user, for example, the insurance adjuster in the example discussed above, may carry the imaging device and the paper 112 to a location remote from the server 100.

In step 208, the user scans an identification code, e.g., a bar code, that was printed on the paper 112 in step 204, for correlation of the digital image captured in step 206. For example, the user may select an unfilled space for a handwritten information and scan the corresponding handwriting ID bar code as depicted in FIG. 4.

In step 210, the user enters handwritten information, such as a description or the user's observations, into the unfilled space selected in step 208. For example, the handwritten information may relate to the digital image that was captured in step 206.

In step 212, the method checks whether more digital images are to be captured. For example, the paper 112 may be configured to receive a pre-determined number of pieces of handwritten information and pictures, for example, four pieces of handwritten information and pictures are to be captured on the paper 112 depicted in FIG. 4. Thus, up to four digital images may be captured, each digital image associated with a corresponding piece of handwritten information. Alternatively, the user may be prompted whether more digital images are to be captured.

In step 214, the digital images and the associated identification codes are transferred to the server 100 from the imaging device. For example, the digital camera 114 is connected to the digital camera interface 110 as illustrated in FIG. 1, and the digital camera 114 may then transmit digital images and bar codes stored in its memory to the server 100.

In step 216, the paper 112 is scanned by the scanner 108, for example, by feeding the paper 112 into the scanner 108.

In step 218, the server 100 associates the handwritten information with the corresponding digital images and identification codes. For example, each handwritten information is associated with a corresponding bar code on the paper 112, and each digital image is associated with a corresponding bar code scanned in step 208. The server 100 associates a piece of handwritten information with a digital image if they are both associated with the same bar code.

In step 220, the server 100 stores the digital images, the handwritten information and the bar codes in data structures on a database 104 or other storage device which may be arranged as illustrated in FIGS. 5a and 5b. For example, the database 104 may be in communication with the server 100 as illustrated in FIG. 1.

In step 222, the procedure may optionally display the database records to the user. For example, the server 100 may display each piece of handwritten information and digital picture of a paper 112 to the user on a screen. Alternatively or additionally, the server 100 may print an output paper including each piece of handwritten information and digital picture of a paper 112.

FIG. 3 schematically illustrates a digital camera 114 as may be used in the system 10. The digital camera 114 includes a memory 306 in which digital images and identification code data are stored. The digital camera 114 also includes a sensor 302 configured to capture an image, for example, a charge coupled device (CCD), a complementary metal oxide semiconductor (CMOS), etc. The sensor 302 takes a picture, which is converted into a digital image by an analog-to-digital converter (ADC) and is stored in the memory 306. The digital camera 114 may also include an integrated barcode scanner 304, or the barcode scanner 304 may be separate from the digital camera 114. The user may scan the bar code with the scanner 304 before or after an image is captured with the sensor 302. The digital camera 114 may be configured to associate the image with the scanned bar code.

The digital camera 114 may be replaced by alternative capture devices, for example, a digital voice recorder may be used to capture a digital voice file and associated with a bar code, or an image scanner may be used to capture an image, e.g., of an x-ray, MRI scan, CAT scan, etc.

As indicated above, the digital camera 114 may be a Ricoh Caplio Pro G3 digital camera with an optional barcode scanner module.

FIG. 4 illustrates a paper 112 as may be used in the system 10. A paper 112 may be of any size or stock, but conventional paper such as letter-size or A4-size paper may be used for ease of printing by the printer 106 and scanning by the scanner 108 of the system 10. The paper 112 may include a plurality of defined spaces for receiving the handwritten information along with identifiers. For example, the paper 112 may include handwriting spaces 402, 406, 410, 414. Each handwriting space may be associated with a corresponding handwriting ID 404, 408, 412, 416. For example, the space 402 is associated with handwriting ID 404, the space 406 is associated with handwriting ID 408, the space 410 is associated with handwriting ID 412, and the space 414 is associated with handwriting ID 416. The spaces 402, 406, 410 and 414 may be lined to guide the user in writing, for example, with a pen, pencil, or other marking instrument.

The handwriting IDs 404, 408, 412 and 416 may be machine-readable codes, such as bar codes. The paper 112 may also include a paper identifier 418, such as a machine-readable code, for example, a bar code.

The paper 112 may be configured to be easily scanned by the scanner 108, and the paper identifier 418 may be scanned and associated with all other information on the paper 112. Each handwritten information may be scanned, and a digital image of the scanned handwritten information may be saved and may be fed into text-recognition software to extract text. Each handwriting ID 404, 408, 412, 416 may be scanned and associated with the corresponding handwritten information.

Alternatively, the paper 112 may be replaced by a digital computer, such as a personal digital assistant (PDA) or a tablet computer, etc. The digital computer may include hardware and software to provide functionality of the paper 112. For example, the digital computer may associate a set of handwritings and handwriting identifiers with a paper identifier.

The digital computer may be configured to capture a handwriting through a handwriting recognition system including software, a touch-sensitive pad and a stylus. Alternative input methods may be used, such as a keyboard or a virtual keyboard.

The digital computer may be configured to provide handwriting identifiers to a data capture device. The digital computer may transmit handwriting identifiers to the data capture device via. a wireless link, such as Bluetooth or an infrared red (IR) system or via. a wired link. Alternatively, the digital computer may display a machine-readable code for the data capture device to scan.

FIG. 5a illustrates a data structure that may be used in the system 10. A data structure 502 may include a plurality of records 504, each record 504 representing one handwritten information and properties associated with the handwritten information.

It will be appreciated that the data structure 502 may be stored in a variety of manners accessible to a server 100. For example, it may be stored as a tab-delimited or comma-delimited flat file, in a relational database or another storage mechanism accessible to a server 100.

FIG. 5b illustrates a data structure entry that may be used in the system 10. Each data structure entry may be a record 504′. The record may represent a handwritten information and an associated digital image stored in the data structure 502.

The record 504′ may include a variety of information, such as a WritingID 512, which may store an identifier associated with the handwritten information. For example, WritingID 512 may be unique within the data structure 502 and may be a string of alpha-numeric characters or an integer. The record 504′ may include a WritingBarCode 514, which may store an integer representation of a bar code associated with the handwritten information. Alternatively, WritingBarCode 514 may store any other digital representation of a bar code.

The record 504′ may include a WritingImage 516, which may store an image file of the handwritten information when it was scanned. WritingImage 516 may be stored for audit or error-checking purposes. WritingImage 516 may also be available to a user if the system is unable to convert the handwritten information into text stored in the database 104. Alternatively, WritingImage 516 may store a path name to a digital image stored on the server 100.

The record 504′ may include a WritingText 518, which may store a digital representation of a text converted from the handwritten information stored in WritingImage 516. For example, the text may be converted from the handwritten information through handwriting-recognition software in the server 100.

The record 504′ may include a PictureID 520, which may be an identifier associated with a digital image. The digital image may be downloaded from the digital camera 114 to the server 100. For example, PictureID 520 may be unique within the data structure 502. For example, PictureID 520 may be a string of alpha-numeric characters or an integer.

The record 504′ may include a PictureFile 522, which may store a digital image associated with the handwritten information. Alternatively, PictureFile 522 may store a path name to a digital image stored on the server 100. For example, the PictureFile 522 may be captured by a digital camera 114 and associated with a handwritten information.

The record 504′ may include a PaperID 524, which may be an identifier associated with each paper 112 in the system, as illustrated in FIG. 4. For example, PaperID 524 may be unique within the data structure 502 and may be a string of alpha-numeric characters or an integer.

It should be appreciated that the digital image may be replaced with another type of digital data. For example, a digital sound recording may be used. It should be appreciated that the handwritten information may be replaced with another type of data. For example, a user may record a digital sound file to be associated with the digital image or data. It should be appreciated that the bar codes may be replaced by any machine-readable code.

It should be appreciated that the paper may be replaced by a digital computer configured to capture handwriting and/or other data input from the user and provide, e.g., handwriting, identifiers to the data capture device, such as a personal digital assistant (PDA) or a tablet computer, etc.

What is claimed is:

1. A method, comprising:
acquiring at least one digital image;
acquiring a first data identifier associated with each digital image;
receiving a scan of a paper including at least one scan of handwritten information and a second data identifier associated with each handwritten information; and
associating each digital image with a corresponding scan of handwritten information in accordance with the first data identifier corresponding to the second data identifier.

2. The method according to claim 1, wherein the first identifier and second data identifier include bar codes.

3. The method according to claim 1, further comprising storing the digital image, the scan of handwritten information, the first data identifier and the second data identifier in a database.

4. The method according to claim 1, further comprising printing the digital image and the associated scan of handwritten information.

5. A method, comprising:
acquiring at least one piece of first data;
acquiring a first data identifier associated with each piece of first data;
receiving a scan including at least one second piece of data and a second data identifier associated with each piece of second data; and
associating each first piece of data with a corresponding second piece of data in accordance with the first data identifier corresponding to the second data identifier.

6. The method according to claim 5, wherein the first piece of data includes at least one of (a) a digital image and (b) a digital sound recording.

7. The method according to claim 5, wherein the second piece of data includes a scan of handwritten information.

8. The method according to claim 5, wherein the scan includes a scan of a paper.

9. The method according to claim 5, wherein the first identifier and the second data identifier include bar codes.

10. The method according to claim 5, further comprising storing the first piece of data, the second piece of data, the first data identifier and the second data identifier in a database.

11. The method according to claim 5, further comprising printing the first piece of data and the second piece of data.

12. A system, comprising:
a medium including at least one second data identifier and a second piece of data associated with each second data identifier;
a data capture device including an identifier scanner adapted to capture the each second data identifier from the medium as a first data identifier and a sensor adapted to capture a first piece of data corresponding to each captured data identifier, the data capture configured to associate each first piece of data with the corresponding data identifier;
a medium scanner configured to scan the medium to acquire each second data identifier and each second piece of data; and
a processor adapted to receive each first piece of data and each first data identifier associated with the first piece of data from the data capture device, to receive each second piece of data and each second data identifier associated with the second piece of data from the medium scanner, and to associate each first piece of data with a corresponding second piece of data in accordance with the first data identifier corresponding to the second data identifier.

13. The system according to claim 12, wherein the medium includes a paper.

14. The system according to claim 12, wherein the medium includes a medium identifier.

15. The system according to claim 12, wherein each data identifier includes a bar code.

16. The system according to claim 12, wherein the first piece of data includes a digital image.

17. The system according to claim 12, wherein the second piece of data includes a scan of handwritten information.

18. The system according to claim 12, wherein the data capture device includes-a digital camera.

19. The system according to claim 12, wherein the sensor includes an image sensor.

20. A system, comprising:
a paper including (a) at least one first data identifier that includes a bar code and (b) a space arranged to receive handwritten information corresponding to each first data identifier;
a camera adapted to capture an image;
a barcode scanner adapted to scan the first data identifier from the paper as a second data identifier;
a scanner adapted to scan the paper and acquire the first data identifier and the handwritten information; and
a processor adapted to receive the image from the camera, to receive the first data identifier and the handwritten information from the scanner, to receive the second data identifier from the barcode scanner, and to correlate the image and the handwritten information in accordance with the first data identifier corresponding to the second data identifier.
